(19) United States
(12) Patent Application Publication
(10) Pub. No.: US 2010/0256295 A1
(43) Pub. Date: Oct. 7, 2010

(54) METHOD FOR PRODUCING MINERAL-BEARING COVER LAYERS FOR FLOOR COVERINGS

(75) Inventors: Nils Mohmeyer, Osnabrueck (DE); Oliver Reese, Lemfoerde (DE); Andrea Eisenhardt, Vechta (DE); Marcus Leberfinger, Georgsmarienhuette (DE); Heinrich Mohmeyer, Alfeld/Leine (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/677,545

(22) PCT Filed: Sep. 12, 2008
(86) PCT No.: PCT/EP2008/062180

§ 371 Date: Mar. 11, 2010

(30) Foreign Application Priority Data
Sep. 14, 2007 (EP) 07116500.5

(51) Int. Cl. C08L 75/04; B05D 3/12

(52) U.S. Cl. 524/589; 427/369

(57) ABSTRACT

The present invention relates to a process for the production of top layers for roads, tracks, and other areas used by traffic, by producing a mixture comprising mineral material and a polyurethane reaction mixture, and also, if appropriate, further additions, applying it to a substrate material, and compacting and hardening it by applying a pressure of at least 5 N/cm², where operations are substantially carried out without use of solvents. The present invention further relates to top layers for roads, tracks, and other areas used by traffic, obtainable by such a process.

The present invention relates to a process for the production of top layers for roads, tracks, and other areas used by traffic, by producing a mixture comprising mineral material and a polyurethane reaction mixture, and also, if appropriate, further additions, applying it to a substrate material, and compacting and hardening it by applying a pressure of at least 5 N/cm², where operations are substantially carried out without use of solvents. The present invention further relates to top layers for roads, tracks, and other areas used by traffic, obtainable by such a process.

Further embodiments of the present invention are found in the claims, in the description, and in the examples. The abovementioned features of the inventive subject matter, and its features that will be explained below, can of course be used not only in the respective stated combination but also in other combinations, without exceeding the scope of the invention.

Top layers for roads are almost exclusively produced from asphalt. To this end, a mineral mixture is applied, with bitumen as binder, to the substrate, and compacted. A disadvantage of these top layers, however, is that they lose strength in particular at high temperatures when these are combined with high load, since bitumen continuously softens as temperature increases. The result of this can be formation of longitudinal grooves or “washboard” structures, produced by braking, standing, and start-up, in particular in front of traffic signals. Top layers based on bitumen moreover become brittle over the course of time, since constituents evaporate from the bitumen over long periods.

Another disadvantage of top layers based on bitumen as binder is that temperatures of at least 180° C. are required for production of the mixtures of mineral material and bitumen, this being a temperature at which viscosity is sufficiently low to ensure adequate wetting of the rock particles. 10 liters of heating oil are therefore needed to heat each metric ton of the mineral mixture. An additional factor is that the mixture is not prepared on site, and this leads to increased truck traffic from the asphalt mixing plant to the installation site. The disadvantages here are not only rising costs for diesel and heating oil but also environmental pollution, in particular the CO₂ emission caused by consumption of diesel and heating oil. A further factor is that used top layers based on bitumen require disposal as special waste, or, after comminution, the amounts that can be added to new asphalt mixes are only small.

Alongside top layers using bitumen as binder, ground-surfacing systems based on plastics as binders are also known. DE 196 05 990, for example, discloses a process for the production of a ground-surfacing system obtainable by mixing of a polymerizable liquid and natural stone. An example of a polymerizable liquid mentioned is a single-component system based on polyurethane.

DE 196 51 749 discloses the production of load-bearing layers as pavement covering in the construction of roads and tracks by mixing of rock material with a thermoplastic adhesive. Alongside the use of thermoplastic adhesive, the use of thermoset adhesive or monoplast adhesive is also mentioned. DE 196 51 749 emphasizes here that thermoplastic adhesives can be compacted effectively during the cooling phase. High load-bearing capability is mentioned as an advantage of thermoset adhesive, which by way of example can be a multicomponent resin adhesive based on polyurethane. There is no disclosure of compaction of rock material and thermoset adhesive.

DE 197 33 588 discloses the production of water-permeable ground-surfacing systems composed of mineral aggregates and of organic adhesive, an example being a two-component epoxy adhesive or two-component polyurethane adhesive. Here, mixtures composed of a mineral substance whose average grain size is preferably from 1 to 5 mm and of the adhesive are mixed and applied, and compacted by applying a pressure of from 1 to 2 N/cm². These coverings are suitable for cycle tracks, traffic-calmed zones, sidewalks, parking areas, sports areas and equestrian areas, yard entrances, and garden paths.

Disadvantages of the known top layers using binders based on polymerizable liquids is their low load-bearing capability. Further disadvantages are that known top layers are susceptible to frost, and that the polymeric binder is rather susceptible to aging.

It was therefore an object of the present invention to provide a top layer which can be produced and installed in an environmentally compatible manner, and has high load-bearing capability, even at high temperatures, and is not susceptible to aging of the binder, and not susceptible to frost/thaw cycles.

This object has been achieved via top layers for roads, tracks, and other areas used by traffic, which are obtainable via the production of a mixture comprising mineral material and comprising a polyurethane reaction mixture, and also, if appropriate, comprising further additions, application of the mixture to a substrate material, compacting of the mixture by applying a pressure of at least 5 N/cm², and hardening of the mixture, where operations are substantially carried out without use of solvents.

The mineral material used here can comprise any known mineral material. Sand or ground rock, known as broken material, can be used here by way of example, where sand has a mainly rounded surface and broken material has edges and fracture surfaces. It is particularly preferable that the mineral material used comprises a material composed mainly of broken material. The mineral material selected preferably comprises, as a function of the intended use, mineral substances with suitable grain size distribution by analogy with the specifications applicable to construction of bituminous road.

The average grain size of the mineral material is preferably from 0.1 to 30 mm, particularly preferably from 1 to 20 mm, and in particular from 2 to 15 mm. The average grain size here is determined by sieving and states the mesh width at which the grain sizes of 50% by weight of the mineral material are smaller than the mesh width, and the grain sizes of 50% by weight of the mineral material are greater than the mesh width. The proportion by weight of mineral material with grain sizes smaller than 0.09 mm here is preferably smaller than 15% by weight, and the proportion by weight of mineral material with grain sizes greater than 16 mm is preferably smaller than or equal to 10% by weight. It is particularly preferable that the proportion of mineral material with grain sizes greater than 11.2 mm is smaller than or equal to 10% by weight. These data are always based on the total weight of the mineral material.

A polyurethane reaction mixture is a mixture composed of compounds having isocyanate groups and compounds having groups reactive toward isocyanates, where the reaction conversion, based on the isocyanate groups used for the preparation of the polyurethane reaction mixture, is preferably smaller than 90%, particularly preferably smaller than 75%, and in particular smaller than 50%. The compounds having groups reactive toward isocyanates here comprise not only high-molecular-weight compounds, such as polyether- and polyesterols, but also low-molecular-weight compounds, such as glycerol, glycol, and also water. If the reaction conversion, based on the isocyanate group, is greater than 90%, the term polyurethane is used below. A polyurethane reaction mixture here can also comprise further reaction mixtures for the production of polymers. Examples of further reaction mixtures that can be used for the production of polymers are reaction mixtures for the production of epoxides, of acrylates, or of polyester resins. The proportion of further reaction mixtures for the production of polymers here is preferably less than 50% by weight, based on the total weight of the polyurethane reaction mixture. It is particularly preferable that the polyurethane reaction mixture comprises no further reaction mixtures for the production of polymers.

The polyurethane reaction mixture can involve what are known as moisture-curing systems. These comprise isocyanate prepolymers which form polyurethanes or polyureas via addition of water or via humidity, mainly by forming urea groups.

It is preferable to use what are known as two-component systems for the production of the polyurethane reaction mixture. For this, an isocyanate component comprising compounds having isocyanate groups, and a polyol component comprising compounds having groups reactive toward isocyanates are mixed in quantitative proportions such that the isocyanate index is in the range from 40 to 300, preferably from 60 to 200, and particularly preferably from 80 to 150.

For the purposes of the present invention, isocyanate index here means the stoichiometric ratio of isocyanate groups to groups reactive toward isocyanate, multiplied by 100. Groups reactive toward isocyanate here means any of the groups which are comprised in the reaction mixture and which are reactive toward isocyanate, and this includes chemical blowing agents, but not the isocyanate group itself.

The polyurethane reaction mixture is preferably obtained by mixing of a) isocyanates with b) relatively high-molecular-weight compounds having at least two hydrogen atoms reactive toward isocyanate, and also, if appropriate, c) chain extenders and/or crosslinking agents, d) catalysts, and e) other additives. Compounds particularly preferably used as components a) and b), and also, if appropriate, c) to e) are those which lead to a hydrophobic polyurethane reaction mixture and to a hydrophobic polyurethane.

Isocyanates a) that can be used are in principle any of the room-temperature-liquid isocyanates, mixtures and prepolymers having at least two isocyanate groups. Aromatic isocyanates are preferably used, particularly isomers of tolylene diisocyanate (TDI) and of diphenylmethane diisocyanate (MDI), in particular mixtures composed of MDI and of polyphenylene polymethylene polyisocyanates (crude MDI). The isocyanates can also have been modified, for example by incorporating isocyanurate groups and carbodiimide groups, and in particular by incorporating urethane groups. The last-mentioned compounds are prepared via reaction of isocyanates with a substoichiometric amount of compounds having at least two active hydrogen atoms and are usually termed NCO prepolymers. Their NCO content is mostly in the range from 2 to 32% by weight. The isocyanates a) preferably comprise crude MDI, with resultant increase in the stability of the polyurethane obtained.

A disadvantage with the use of aromatic isocyanates is the inadequate colorfastness of the polyurethanes produced therefrom. Marked yellowing of the polyurethanes mostly occurs over the course of time. In applications of the inventive process where high colorfastness is important, it is therefore preferable to use mixtures comprising aliphatic isocyanates and aromatic isocyanates. It is particularly preferable to use exclusively aliphatic isocyanates. In one particular embodiment, an overlayer composed of polyurethane based on an aliphatic isocyanate can be used, in order to protect the top layer based on aromatic isocyanate from yellowing. The overlayer here can also comprise mineral material. Preferred representative compounds are hexamethylene diisocyanate (HDI) and isophorone diisocyanate (IPDI). Because the aliphatic isocyanates have high volatility, they are mostly used in the form of their reaction products, in particular in the form of biurets, allophanates, or isocyanurates. The aliphatic compounds can likewise be reacted and used with any of the conceivable polyols, in particular those listed under b), to give prepolymers.

The relatively high-molecular-weight compounds b) used having at least two hydrogen atoms reactive toward isocyanate are preferably compounds which have hydroxy groups or amino groups as group reactive toward isocyanate. It is preferable to use polyhydric alcohols, since the amino groups are highly reactive and the reaction mixture therefore has to be processed rapidly. Amino groups moreover led to formation of urea groups, which in turn harden to give a rather brittle polyurethane.

The relatively high-molecular-weight, polyhydric alcohols used can by way of example be polyethers or polyesters. Further compounds having at least two hydrogen atoms reactive toward isocyanate groups can be used together with the compounds mentioned. Polyether alcohols are preferred by virtue of their high hydrolysis resistance. These are prepared by conventional and known processes, mostly via an addition reaction of alkylene oxides onto H-functional starter substances. The functionality of the polyether alcohols used concomitantly is preferably at least 3 and their hydroxy number is preferably at least 400 mg KOH/g, preferably at least 600 mg KOH/g, in particular in the range from 600 to 1000 mg KOH/g. They are prepared conventionally via reaction of at least trifunctional starter substances with alkylene oxides. Starter substances that can be used are preferably alcohols having at least three hydroxy groups in the molecule, examples being glycerol, trimethylolpropane, pentaerythritol, sorbitol, and sucrose. Propylene oxide is preferably used as alkylene oxide.

Inventive reaction mixtures preferably comprise compounds having hydrophobic groups. These particularly preferably involve hydroxy-functionalized compounds having hydrophobic groups. These hydrophobic groups have hydrocarbon groups preferably having more than 6, particularly preferably more than 8, and fewer than 100, and in particular more than 10 and fewer than 50, carbon atoms. The compounds having hydrophobic groups can be used as separate component or as constituent of one of components a) to e), for preparation of the reaction mixture. The hydroxy-functionalized hydrophobic compounds preferably involve compounds b) which comply with the definition of the relatively high-molecular-weight compounds having at least two hydrogen atoms reactive toward isocyanates. Component b) here can comprise hydroxy-functionalized hydrophobic compounds or preferably be composed thereof.

The hydroxy-functionalized hydrophobic compound used is preferably a hydroxy-functionalized compound known in oleochemistry, or a polyol known in oleochemistry.

A number of hydroxy-functional compounds that can be used are known in oleochemistry. Examples are castor oil, oils modified using hydroxy groups, e.g. grapeseed oil, black cumin oil, pumpkin seed oil, borage seed oil, soybean oil, wheatgerm oil, rapeseed oil, sunflower oil, peanut oil, apricot seed oil, pistachio oil, almond oil, olive oil, macadamia nut oil, avocado oil, sea buckthorn oil, sesame oil, hazelnut oil, evening primrose oil, wild rose oil, hemp oil, thistle oil, walnut oil, fatty acid esters modified using hydroxy groups and based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid, or cerevonic acid. It is preferable here to use castor oil and its reaction products with alkylene oxides or with ketone-formaldehyde resins. The last-named compounds are marketed by way of example by Bayer AG as Desmophen® 1150.

Another group of polyols which are known in oleochemistry and whose use is preferred can be obtained via ring-opening of epoxidized fatty acid esters with simultaneous reaction with alcohols and, if appropriate, subsequent further transesterification reactions. Incorporation of hydroxy groups into oils and fats occurs primarily via epoxidization of the olefinic double bond comprised in these products, followed by reaction of the resultant epoxy groups with a mono- or polyhydric alcohol. The product here of the epoxy ring is a hydroxy group or, in the case of polyhydric alcohols, a structure having a relatively high number of OH groups. Since oils and fats are mostly glycerol esters, parallel transesterification reactions proceed with the abovementioned reactions. The molar mass of the resultant compounds is preferably in the range from 500 to 1500 g/mol. These products are supplied by way of example by Henkel.

In one particularly preferred embodiment of the inventive process, the relatively high-molecular-weight compound b) having at least two hydrogen atoms reactive toward isocyanate comprises at least one polyol known in oleochemistry and at least one phenol-modified aromatic hydrocarbon resin, in particular one indene-coumarone resin. Polyurethane reaction mixtures based on said component b) have a level of hydrophobic properties which is sufficiently high that in principle they can even be hardened under water, or installed during rainfall.

The phenol-modified aromatic hydrocarbon resin used having a terminal phenol group is preferably phenol-modified indene-coumarone resins, and particularly preferably industrial mixtures of aromatic hydrocarbon resins. These products are commercially available and are supplied by way of example by Rütgers VFT AG as NOVARES®.

The OH content of the phenol-modified aromatic hydrocarbon resins, in particular the phenol-modified indene-coumarone resins, is mostly from 0.5 to 5.0% by weight.

The polyol known from oleochemistry and the phenol-modified aromatic hydrocarbon resin, in particular the indene-coumarone resin, are preferably used in a ratio by weight of from 100:1 to 100:50.

Preparation of an inventive polyurethane reaction mixture can use a chain extender c). However, the chain extender c) can also be omitted here. However, the addition of chain extenders, crosslinking agents, or else, if appropriate, a mixture of these can prove successful for modification of mechanical properties, e.g. hardness.

If low-molecular-weight chain extenders and/or crosslinking agents c) are used, the preparation of polyurethanes can use known chain extenders. These are preferably low-molecular-weight compounds having groups reactive toward isocyanates whose molar mass is from 62 to 400 g/mol, examples being glycerol, trimethylolpropane, known glycol derivatives, butanediol, and diamines. Other possible low-molecular-weight chain extenders and/or crosslinking agents are given by way of example in “Kunststoffhandbuch, Band 7, Polyurethane” [Plastics Handbook, volume 7, Polyurethanes], Carl Hanser Verlag, 3rd edition 1993, chapter 3.2 and 3.3.2.

The polyurethanes used can in principle be prepared without the presence of catalysts d). Catalysts d) can be used concomitantly to improve hardening. The catalysts d) selected should preferably be those that maximize reaction time. It is thus possible that the polyurethane reaction mixture remains liquid for a long period. These catalysts are known to the person skilled in the art. It is also possible in principle, as described, to work entirely without catalyst.

Other conventional constituents can be added to the polyurethane reaction mixture, examples being conventional additives e). These comprise by way of example conventional fillers. The fillers used are preferably the conventional, organic and inorganic fillers, reinforcing agents, and weighting agents known per se. Individual examples that may be mentioned are: inorganic fillers, such as silicatic minerals, e.g. phyllosilicates, such as antigorite, serpentine, hornblendes, amphiboles, chrysotile, metal oxides, such as kaolin, aluminum oxides, titanium oxides, and iron oxides, metal salts, such as chalk, barite, and inorganic pigments, such as cadmium sulfide, zinc sulfide, and also glass. It is preferable to use kaolin (China clay), aluminum silicate, and coprecipitates composed of barium sulfate and aluminum silicate, and also natural and synthetic fibrous minerals, such as wollastonite, metal fibers of various lengths, and in particular glass fibers of various lengths, which may, if appropriate, have been coated with a size. Examples of organic fillers that can be used are: carbon black, melamine, rosin, cyclopentadienyl resins, and graft polymers, and also cellulose fibers, polyamide fibers, polyacrylonitrile fibers, polyurethane fibers, polyester fibers based on aromatic and/or aliphatic dicarboxylic esters, and in particular carbon fibers.

If the abovementioned inorganic fillers are used as additives e), their mineral substance constitution preferably differs from that of the mineral material, and they are ignored when determining the grain size distribution of the mineral material.

The inorganic and organic fillers can be used individually or in the form of a mixture, and their amounts comprised in the reaction mixture are preferably from 0.5 to 50% by weight, particularly preferably from 1 to 40% by weight, based on the weight of components a) to e).

The polyurethane reaction mixture should also comprise dryers, such as zeolites. These are preferably added, prior to preparation of the inventive reaction mixture, to the compounds b) having at least two hydrogen atoms reactive toward isocyanate, or to the component which comprises the compounds b) having at least two hydrogen atoms reactive toward isocyanate. Addition of the dryers avoids any increase in the concentration of water in the components or in the reaction mixture, and thus avoids formation of foamed polyurethane. Additions preferred for water adsorption are aluminosilicates, selected from the group of the sodium aluminosilicates, potassium aluminosilicates, calcium aluminosilicates, cesium aluminosilicates, barium aluminosilicates, magnesium aluminosilicates, strontium aluminosilicates, sodium aluminophosphates, potassium aluminophosphates, calcium aluminophosphates, and mixtures thereof. It is particularly preferable to use mixtures of sodium aluminosilicates, potassium aluminosilicates, and calcium aluminosilicates in castor oil as carrier substance.

To improve the long-term stability of the inventive top layers, it is moreover advantageous to add agents to counter attack by microorganisms. Addition of UV stabilizers is also advantageous, in order to avoid embrittlement of the moldings. These additives are known, and examples are given in “Kunststoffhandbuch, Band 7, Polyurethane” [Plastics Handbook, volume 7, Polyurethanes], Carl Hanser Verlag, 3rd edition 1993, chapter 3.4.

It is preferable that the components c), d), and e) are added to the compounds having at least two hydrogen atoms reactive toward isocyanate groups. This blend is often referred to in industry as polyol component.

The ratio in which the isocyanates are combined with the compounds having at least two hydrogen atoms reactive toward isocyanate groups should preferably be such that a stoichiometric excess of isocyanate groups is present.

In one preferred embodiment of the invention, polyurethane reaction mixtures are used which lead to hydrophobic, substantially compact polyurethanes. A polyurethane is termed compact polyurethane if it is substantially free from gas inclusions. The density of a compact polyurethane is preferably greater than 0.8 g/cm³, particularly preferably greater than 0.9 g/cm³, and in particular greater than 1.0 g/cm³.

An inventive mixture for the production of top layers can also comprise further additions alongside polyurethane reaction mixture and mineral material. The additions preferably comprise materials which inhibit flow of the binder away from the mineral material. Examples of possible such additions are organic fibers, such as cellulose fibers. It is moreover possible to add polymers which are nowadays used in the bitumen-based systems used. These are especially neoprenes, styrene-butadiene-styrene, block copolymers, or a mixture of these, or else any of the other known rubbers and their mixtures. The additions can either be added directly to the mineral mixture in the form of powder or pellets or else dispersed in one of the polyurethane components.

No restriction is placed on the preparation of the inventive mixtures for the production of top layers. They can by way of example be prepared in mixers to which the mineral material is introduced, and the starting components for the preparation of the polyurethane reaction mixture can, for example, be introduced by spraying. Additions to be added here, if appropriate, are preferably added to the mixture at the respective advantageous juncture. By way of example, therefore, these may be in solution or dispersion in one of the components of the reaction mixture, for example in one of components a) to e), and may be added with these to the mixture. The additions can also be separately added to the mixture. By way of example, cellulose fibers can be added at a juncture such that these are present in homogeneous dispersion in the mixture for the production of top layers, but are not irreversibly damaged by the mixing procedure. The inventive mixture here for the production of top layers can by way of example be produced by the process described in DE 196 32 638. It is likewise possible, for example, to begin by preparing the polyurethane reaction mixture and then to mix this with the mineral material and, if appropriate, with the further additions. In another embodiment, the mineral material can, if appropriate, first be mixed with some of the components of the reaction mixture, for example with components b) and, if present, c) to e), and then the components not yet present, for example component a), can be added in a mixer.

The hydrophobic polyurethane reaction mixtures whose use is preferred feature particularly good processibility. These polyurethane reaction mixtures and the polyurethanes obtained therefrom therefore exhibit particularly good adhesion, in particular also on moist substrates, such as wet mineral material. The hardening of the polyurethane reaction mixture takes place in practically compact form despite the presence of water. There is therefore no essential requirement for drying of the mineral material prior to preparation of the mixture.

When the inventive mixture for the production of top layers is applied to the substrate material, there is no requirement that the substrate material is dry. Surprisingly, even in the presence of wet substrate material it is possible to obtain good adhesion between the top layer and the substrate material. The substrate material used here, known as the underlayer or binder layer, is preferably a material also used in construction of bituminous roads.

In another embodiment, the production of the substrate material can also use a mixture comprising an inventive polyurethane reaction mixture and mineral material. The mineral material used here comprises the mineral material usually used for the production of the substrate material. The grain size distribution of the mineral material for the production of the substrate material is the same here as the grain size distribution of the mineral material usually used for the production of the substrate material in the construction of bituminous roads. The mixture for the production of substrate material can also comprise, alongside mineral material and polyurethane reaction mixture, further substances, such as bitumen, or the substances usually used for the production of the substrate material. The method for preparation of the mixture here is preferably analogous to that for preparation of the mixture for the production of top layers.

This mixture for the production of the substrate material can by way of example be applied to loose rubble material, and then is preferably compacted and hardened. It is also possible here to use a plurality of layers of substrate material, where these differ by way of example in the proportion of polyurethane reaction mixture and/or in the grain size distribution of the mineral material.

After application of the inventive mixture for the production of top layers, this can then be covered with scattered sand. The mixture can, if appropriate, be slightly compacted prior to the scattering process.

After application to the substrate material, the inventive mixture for the production of a top layer is compacted. A pressure greater than 5 N/cm² is preferably applied here. It is particularly preferable to use, for the compaction process, a roll which compacts the inventive mixture for the production of top layers with a static linear pressure of from 7 kg/cm to 50 kg/cm, in particular from 10 kg/cm to 40 kg/cm. This type of roll can also be used in vibration mode. Surprisingly, in particular highly compacted top layers exhibit low susceptibility of the polyurethane to hydrolysis and frost-thaw cycles.

Inventive top layers for roads, tracks, and other areas used by traffic are preferably applied at a thickness greater than 0.5 cm. Application thicknesses up to one meter are possible in particular cases, for example for runways. The thickness of the top layers is particularly preferably from 1 to 10 cm, in particular from 2 to 6 cm. The proportion by weight of the polyurethane reaction mixture and, if appropriate, of additions added here is preferably from 1 to 20% by weight, particularly preferably from 2 to 15% by weight, and in particular from 5 to 10% by weight, based on the total weight of the inventive mixture for the production of top layers.

The bond between mineral material and inventive binder is very secure. Practically no hydrolytic degradation of the polyurethanes occurs moreover, in particular when hydroxy-functional compounds having hydrophobic groups are used, the result therefore being durability over a very long period of the top layers produced by the inventive process. Inventive top layers have particularly good load-bearing properties and are therefore suitable for all roads, tracks, and areas used by traffic, and particularly for runways and roads of construction class V to I, in particular from III to I, which are subject to relatively high loads, and runways, where roads of construction class V are access roads and roads of construction class I are motorways and highways. The mineral material used is preferably the recommended materials for the respective construction class.

A further advantage of inventive top layers is their good environmental compatibility. Used top layers are therefore unlike top layers based on bitumen in not requiring disposal as special waste. The high-energy-cost production process is also omitted, the result being less emission of CO₂ in the production process. Particularly when hydrophobic reaction mixtures are used, surprisingly little frost damage occurs. A further advantage of inventive top layers is low repair cost. It is sufficient to produce small amounts of the mixture for the production of a top layer on site, without heating, and to apply this to the damaged site, and to compact it. Furthermore, the mechanical properties of the inventive top layers continue unchanged for a number of years. A further advantage of inventive top layers is improved wet slip resistance, in particular in the case of top layers with high polyurethane content, when comparison is made with top layers with high bitumen content.

The invention is illustrated by an example below:

Polyurethane Reaction Mixture 1:

100 parts by weight of the polyol component of the Elastan 6551/101 system and 50 parts by weight of IsoPMDI 92140, a preparation comprising diphenylmethane diisocyanate (MDI) were mixed with one another.

Specimen 1

10 parts by weight of polyurethane reaction mixture 1 are mixed with 100 parts by weight of a mineral mixture (grain size ⅓, Piesberger) in a mixing unit, charged to a 100×100×100 mm mold and compacted using 8.5 N/mm².

The properties of the resultant specimen 1 were determined to DIN EN 12390-3, DIN CEN/TS 12390-9, DIN 18035-5 and D-N EN 12697-22 after storage for more than 24 hours, and have been listed in Table 1.

An external testing institute evaluated slip resistance and grip as favorable.

TABLE 1

| | Specimen 1 |
|---|---|
| Compressive strength (N/mm²) | >11 |
| Ablation due to weathering (g/m²) | <30 |
| Water infiltration rate (m/s) | 0.3 |
| Resistance to deformation (mm) | <1 |

Table 1 shows that the specimen 1 produced has high resistance in particular to deformation (formation of longitudinal grooves) and to ablation due to weathering, and can therefore be used as a top-layer material.

1. A process for producing a top layer comprising producing a mixture (A) comprising a mineral material, a polyurethane reaction mixture (B), and optionally, a further addition, applying the mixture (A) to a substrate material, and compacting and hardening the mixture (A) by applying a pressure of at least 5 N/cm², where the process is substantially carried out without use-of solvents.

2. The process according to claim 1, wherein the substrate material is obtained by applying and hardening the mixture (A) comprising a mineral material and a polyurethane reaction mixture.

3. The process according to claim 1, wherein the polyurethane reaction mixture is obtained by mixing
a) an isocyanate with
b) a compound having at least two hydrogen atoms reactive toward isocyanate, and also, optionally,
c) at least one of chain extender and crosslinking agents,
d) a catalyst, and
e) one or more other additives.

4. The process according to claim 3, wherein the isocyanate a) is an aromatic isocyanate.

5. The process according to claim 3, wherein the isocyanate a) is an aliphatic isocyanate or a mixture comprising aliphatic and aromatic isocyanates.

6. The process according to claim 3, wherein the compound b) having at least two hydrogen atoms reactive toward isocyanate comprises a hydroxy-functional compound having hydrophobic groups.

7. The process according to claim 6, wherein the hydroxy-functional compound having hydrophobic groups comprises a hydroxy-functional compound known in oleochemistry.

8. The process according to claim 6, wherein the compound b) having at least two hydrogen atoms reactive toward isocyanate comprises a hydroxy-functional compound known in oleochemistry and a phenol-modified aromatic hydrocarbon resin.

9. The process according to claim 3, wherein an average functionality of the compound b) having at least two hydrogen atoms reactive toward isocyanate is greater than 2.

10. The process according to claim 1, wherein a proportion of the polyurethane reaction mixture in the top layer is from 1 to 20% by weight, based on the total weight of the mixture (A).

11. The process according to claim 1, wherein the mineral material mainly comprises broken material.

12. The process according to claim 1, wherein the mixture (A) comprises further additions.

13. The process according to claim 12, wherein the mixture (A) comprises fibers as additions.

14. The process according to claim 1, wherein a thickness of the top layer is from 0.5 to 15 cm.

15. A top layer for roads, tracks, and other areas used by traffic, obtained by the process according to claim 1.
